(19) United States
(12) Patent Application Publication
(10) Pub. No.: US 2007/0235140 A1
(43) Pub. Date: Oct. 11, 2007

(54) LABELING APPARATUS FOR APPLYING FILM LABELS

(76) Inventors: Jerry Schuler, Hamilton, IL (US); Brad Schuler, Hamilton, IL (US); Richard Lavosky, Clarksville, TN (US)

Correspondence Address: Baker, Donelson, Bearman,;Caldwell & Berkowitz, P.C., Commerce Center, Suite 1000, 211 Commerce Street, Nashville, TN, 37201, US

(21) Appl. No.: 11/697,277

(22) Filed: Apr. 5, 2007

Related U.S. Application Data
(60) Provisional application No. 60/744,290, filed on Apr. 5, 2006.

(51) Int. Cl. B32B 37/12; B32B 37/00

(52) U.S. Cl. 156/538; 156/578; 156/497; 156/499

(57) ABSTRACT

Improvements to an automatic cold glue labeling machine having a label magazine, a rotary gripper cylinder for applying labels to containers, and a label transfer mechanism for transferring labels from the magazine to the rotary gripper cylinder. The transfer mechanism comprises a series of rotary glue pallets and a rotating glue pallet carrier on which the glue pallets orbit past the magazine to sequentially roll over the foremost label in the magazine to pick said foremost label out of the magazine and orbit past the rotary gripper cylinder whose finger assembly grasps and transfers the label thereto. The adhesive transfer surface of said glue pallets smoothly applies clear drying, high wet tack adhesives to film labels, and the modified profile of the gripping surfaces of the gripper cylinder finger and anvil assemblies reduces or eliminates finger marks on said label. An elastomer foam adhesive transfer face for each glue pallet and matched pairs of rounded convex-concave finger-anvil profiles for each finger-anvil assembly on said gripper cylinder. A heater apparatus also is disclosed.

This application claims benefit of, and priority to, U.S. Provisional Patent Application No. 60/744,290, filed Apr. 5, 2006, entitled “LABELING APPARATUS FOR APPLYING FILM LABELS.” The specifications, drawings, and complete disclosure of U.S. Provisional Patent Application No. 60/744,290 are incorporated herein by specific reference.

### FIELD OF INVENTION

This invention relates to opaque or transparent film labels that are applied to surfaces, including surfaces and containers made of glass, metal, or plastic, using cold (or “wet”) glue labeling machines, and the labeling apparatus to apply such labels. More particularly, the present invention relates to the application of transparent or clear labels so as to achieve a “no-label” appearance on the surface using a wet glue labeling machine.

### BACKGROUND OF INVENTION

The present invention relates to a labeling machine for applying labels to containers comprising at least one glue pallet which is mounted on a revolving carrier and is adapted to rotate or swing about its own axis, and which after having its adhesive transfer surface coated with glue by a rotating glue roller picks up from a label magazine, and in particular from a stack of labels, the foremost label and transfers it to a labeling means, in particular a rotating gripper cylinder, which then affixes the label by its glue-coated side to a container moving past it, the thickness of the layer of glue applied to the surface of the glue roller by an applicator means, in particular a nozzle, being adjustable by means of a doctor blade whose spacing from the glue-roller surface can be varied.

In known labeling machines of this kind as disclosed in U.S. Pat. Nos. 4,279,687 and 4.445,961 the glue pallets and the gripper cylinder were designed to transfer and apply paper labels using casein and non-casein waterbase glues known to the art. A common cause of trouble in the prior art labeling station was applying an adequate amount of glue to the paper label to achieve adhesion to a container. To overcome this difficulty, it is known to use rubber-faced glue rollers in conjunction with grooved aluminum glue pallets. Aluminum has a high surface energy making the material receptive to waterbase adhesives, and the grooved aluminum glue pallets are capable of transferring large amounts of wet glue to the paper label. While this eliminates the trouble of applying an adequate amount of glue, a further cause of trouble persists in the handling of labels, and that is the amount of wet glue on the label causes the label to move or “swim” on the container. To overcome this difficulty, it is known to use sharp-pointed fingers on the gripper cylinder to firmly hold the label until transfer to the container is complete.

Originally, paper was the most common substrate used for labels. Subsequently, several types of clear or translucent plastic, polyolefin, or polymer labels (i.e., “film labels”) were created. The use of film labels has increased because the appearance when applied to a glass or plastic surface or container simulates “painted glass” so as to provide something approaching a “no label” look. The objective is to have the text and graphics on the label appear to be painted directly on the surface or container itself. In addition, clear film labels when used on containers allow consumers to see the beverage, liquid or product in the container, to the extent the container itself allows.

The apparatus and methods used in the prior art labeling machines to overcome the problems of applying paper labels using casein and non-casein wet glues create a new set of problems when used to apply opaque or clear film labels using synthetic wet glues such as Cork Industries' CB-1000B N•Cryl™ film label adhesive. The prior art aluminum glue pallets have high surface energy; consequently, high wet tack label adhesives such as the CB-1000B form a strong bond between the label and the aluminum glue pallet making it difficult for the gripper cylinder to remove the label from the glue pallet causing misfeeds. The grooves in the prior art glue pallets create noticeable patterns in the wet glue as it is transferred to the film label. Those patterns are easily recognizable through clear film labels detracting from a no label look. Sharply angled and/or pointed gripper cylinder fingers puncture, pucker, and/or mark the edges of the film labels further detracting from the no label look.

Accordingly, what is needed is a labeling apparatus of the type outlined above in which the application of glue to the surface of the film label is smooth and patternless and the gripper cylinder finger and anvil apparatus provides positive control of the film label without puncturing or marring the surface of the film.

### SUMMARY OF THE INVENTION

In one exemplary embodiment, a glue pallet for film labels comprises an aluminum base, and a closed-cell, elastomer adhesive transfer surface such as Plei-Tech Polyurethane as sold by Pleiger Plastics Company of Washington, Pa. The adhesive transfer surface can be made of any suitable non-absorbent, non-swelling, chemical resistant, and abrasion resistant elastomer foam material, including but not limited to closed-cell polyurethane, open-cell polyurethane, closed-cell polypropylene, open-cell polypropylene, and closed cell neoprene. The adhesive transfer surface is permanently bonded to the aluminum base with a layer of high viscosity, rubber-toughened adhesive such as Zip Grip® HV2200 sold by Devcon of Danvers, Mass.

In another exemplary embodiment, a gripper finger and anvil apparatus for film labels comprises a gripper finger with a well-rounded concave contact surface and an anvil with a convex mating surface.

In yet another exemplary embodiment, a hot air adhesive activation apparatus comprises an adjustable air heater, air distribution lines, and air nozzles. The nozzles are mounted in close proximity to the gripper cylinder to apply heated air to the adhesive on the labels on the gripper cylinder just prior to application to the container.

In yet another exemplary embodiment, a container label surface heating apparatus comprises an adjustable air heater, air distribution line, and air nozzles. The nozzles are mounted in close proximity to the bottle platform to apply heated air to the label surface of the container prior to label application.

### DESCRIPTION OF THE DRAWINGS

FIG. 1 shows an exploded view of a glue pallet for film labels in accordance with one embodiment of the present invention.

FIG. 2 shows a plan view of the glue pallet for film labels in accordance with one embodiment of the present invention.

FIG. 3 shows an exploded view of a finger and anvil apparatus for film labels in both open and closed positions including the anvil support and cam roller assemblies in accordance with one embodiment of the present invention.

FIG. 4 shows an isometric view of the assembled finger and anvil apparatus in accordance with one embodiment of the present invention.

FIG. 5 shows a plan view of the finger and anvil apparatus in both the open and closed positions in accordance with one embodiment of the present invention.

FIG. 6 shows a plan view of a gripper cylinder assembly with a hot air adhesive activation apparatus in accordance with one embodiment of the present invention.

FIG. 7 shows a side view of a container, a bottle plate, and a container label surface heating apparatus in accordance with one embodiment of the present invention.

### DETAILED DESCRIPTION OF THE INVENTION

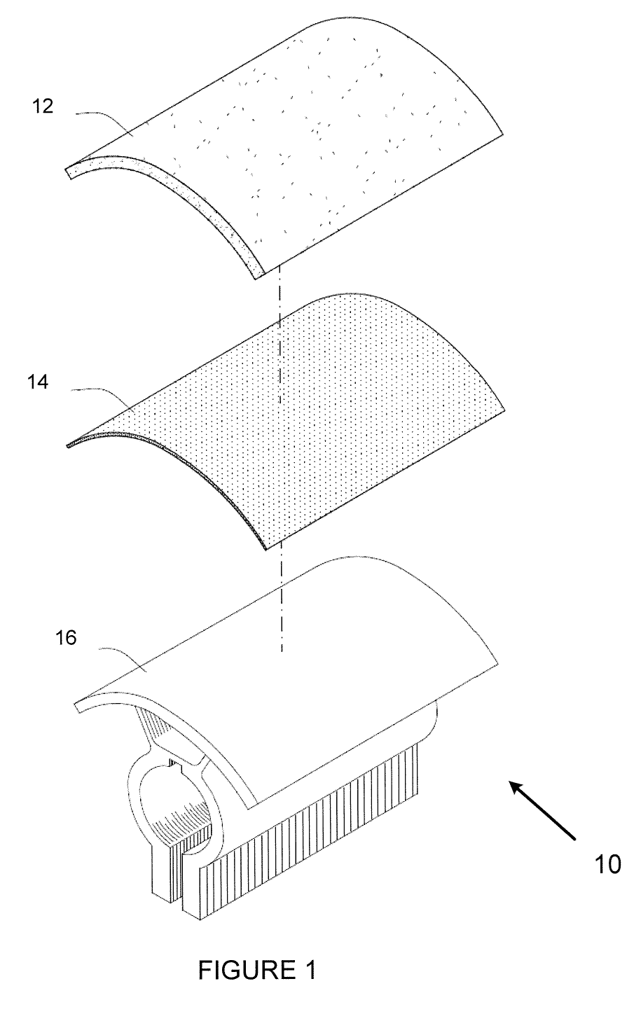

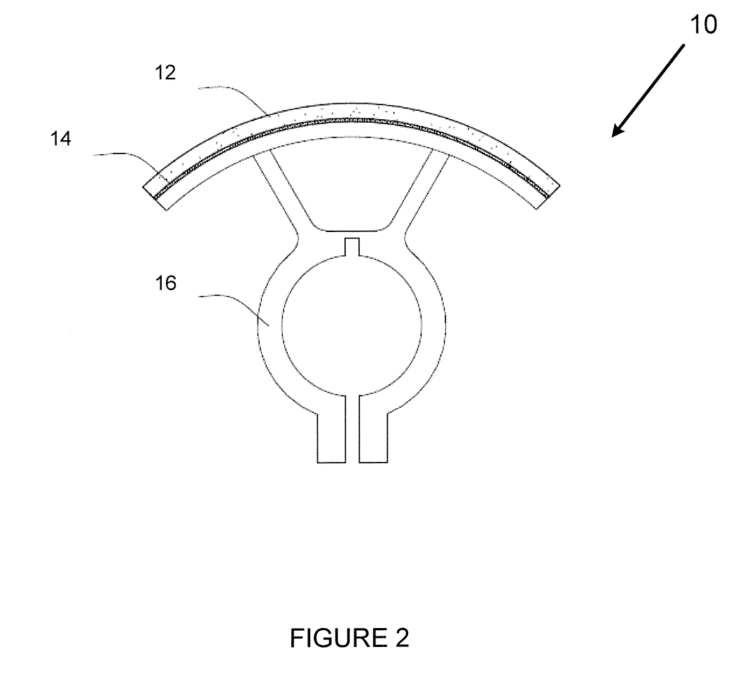

Referring now to the numerous figures, wherein like references identify like elements of the invention, FIGS. 1-2 illustrate an exemplary embodiment of the invention. A glue pallet 10 for film labels comprises a base 16, which may be made of aluminum, a layer of high viscosity, rubber-toughened adhesive 14, such as Zip Grip® HV2200 sold by Devcon of Danvers, Mass., and a nonabsorbent, closed-cell, elastomer adhesive transfer surface 12 such as Plei-Tech Polyurethane as sold by Pleiger Plastics Company of Washington, Pa. The adhesive transfer surface 12 can be made of any suitable non-absorbent, non-swelling, chemical resistant, and abrasion resistant elastomer foam material, or the equivalent, including but not limited to closed-cell polyurethane, open-cell polyurethane, closed-cell polypropylene, open-cell polypropylene, and closed cell neoprene.

The cell structure and polar nature of the polyurethane elastomer foam adhesive transfer surface 12 picks up and transfers wet glue to the film label like a printing plate etched with a random (stochastic) pattern. The low surface energy (less than or equal to 36 dynes/cm) of the elastomer foam permits the smooth transfer of the wet glue to the film label.

In general, when the adhesive layer is perfectly uniform, the label may be called “contact clear” in the industry. However, in practice, the adhesive layer is not always perfectly uniform. Any regular pattern in the glue pallets such as grooves is then formed in the dried glue layer behind the clear film label, resulting in “glue lines” that an observer may perceive as a loss of “contact clear”. The stochastic cell structure of the elastomer foam maintains a random glue pattern in less than perfect application conditions promoting the “no label” look.

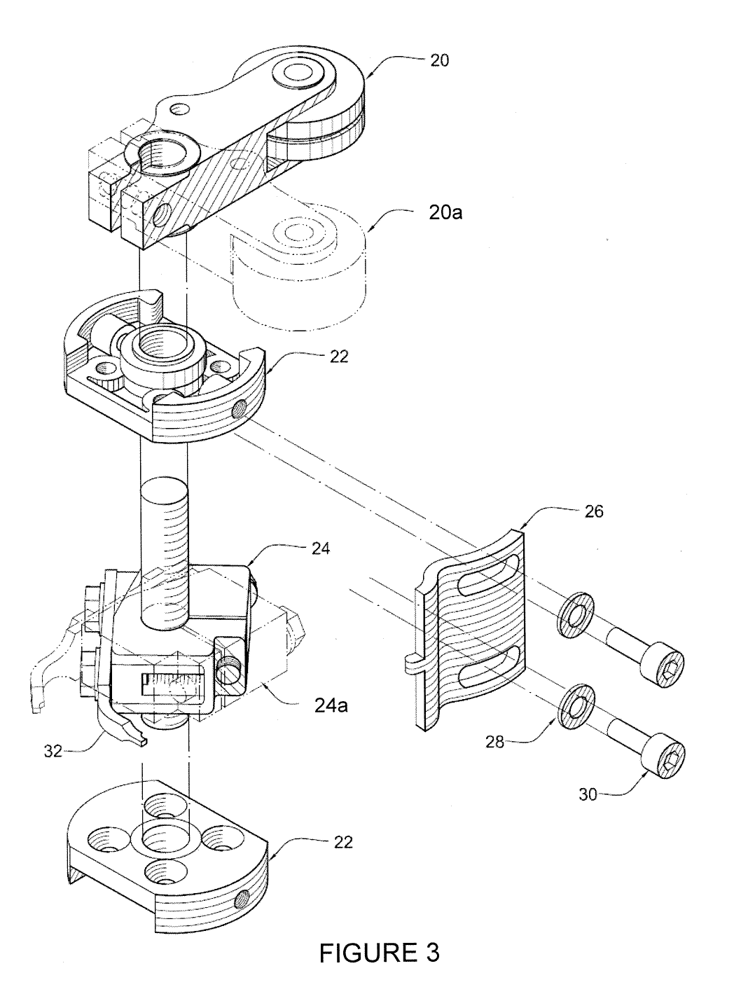

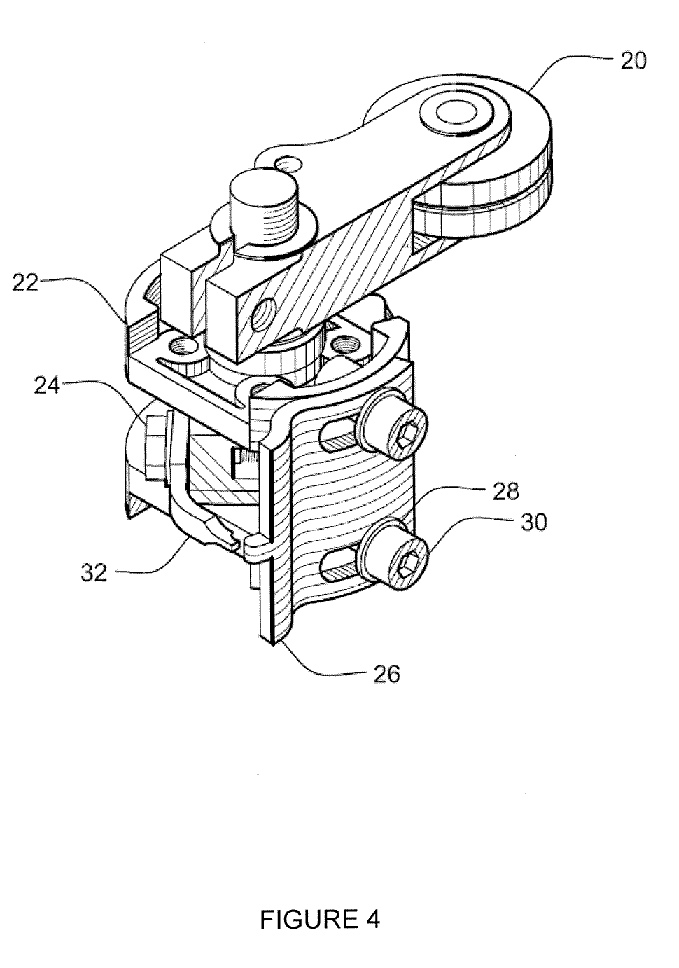

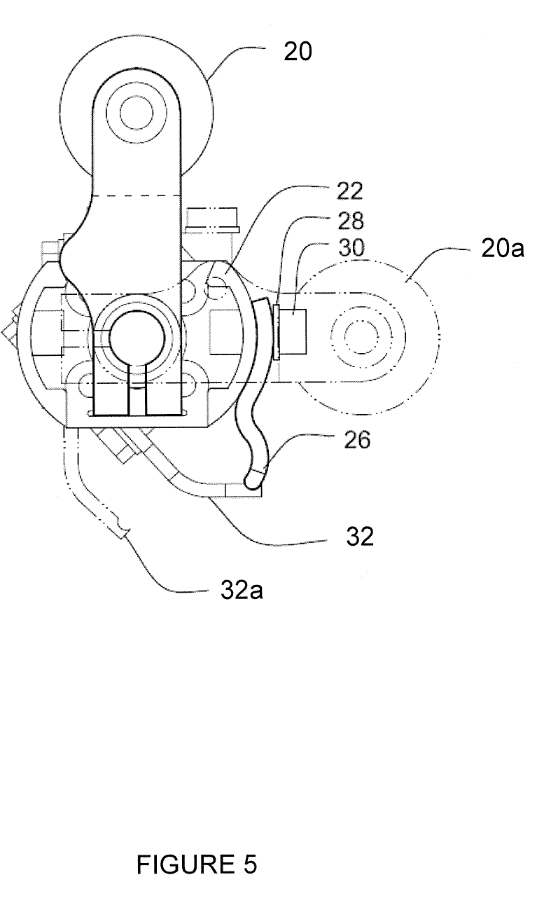

FIGS. 3-5 show an apparatus for applying film labels. The cam follower 20 rolls against the opening and closing cam (not shown), causing gripper finger 32 to pivot in and out to pull label from the glue pallet. Gripper finger 32 is supported by finger support block (pivot block) 24. The well-rounded, concave contact surface of the finger 32 pushes the film label toward the convex mating surface on the anvil 26 to ensure positive control of the film label without puncturing the label. Anvil 26 is fastened to anvil support 22 by plurality of bolts 30 and washers 28. FIGS. 3 and 5 show different positions of cam follower 20, 20a, pivot block 24, 24a, and gripper finger 32, 32a as the cam follower rolls against the cam. The gripper finger 32 and anvil 26 apparatus can be made of any suitable material including but not limited to stainless steel, Teflon®, or brass.

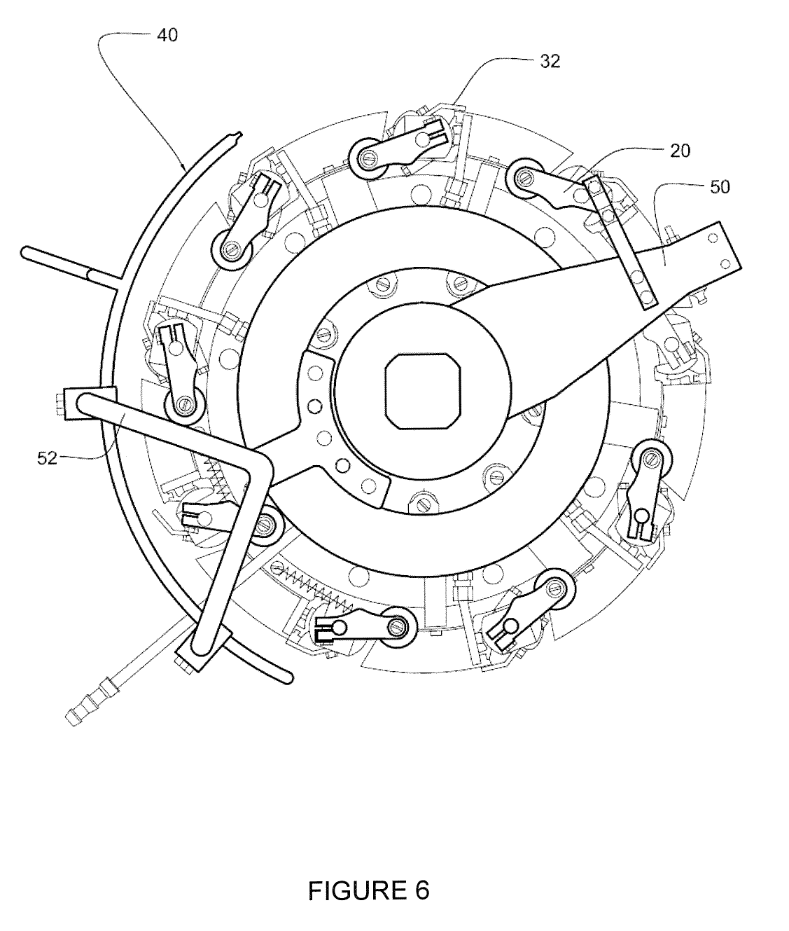

FIG. 6 shows a typical gripper cylinder assembly 50 with the hot air adhesive activation apparatus 40 installed. An air heater assembly (not depicted in FIG. 6) such as a Hot Watt Model #AH37-4MF as sold by Hot Watt of Danvers, Mass. supplies compressed air heated to the range of 150° to 250° F. to the hot air adhesive activation apparatus 40 by means of an aluminum air distribution line 52. In one exemplary embodiment of the invention, the hot air adhesive activation apparatus 40 is constructed of ¼-inch round, 6061 aluminum alloy tube. The tubing is formed into an air ring to match the radius of the gripper cylinder assembly 50. The inside radius of the hot air adhesive activation apparatus 40 has small holes (approximately 0.5 mm in diameter) evenly spaced (approximately 20 mm center-to-center depending on label size) to provide uniform air distribution. Depending on the height of the labels, multiple rings may be connected together to achieve full coverage of heated air across the glue side of the label. As the gripper cylinder assembly 50 transfers a label to a container, the hot air adhesive activation apparatus 40 applies heated air to the wet glue on the label. The heated air initiates the cure of the applied adhesive just prior to application on the container.

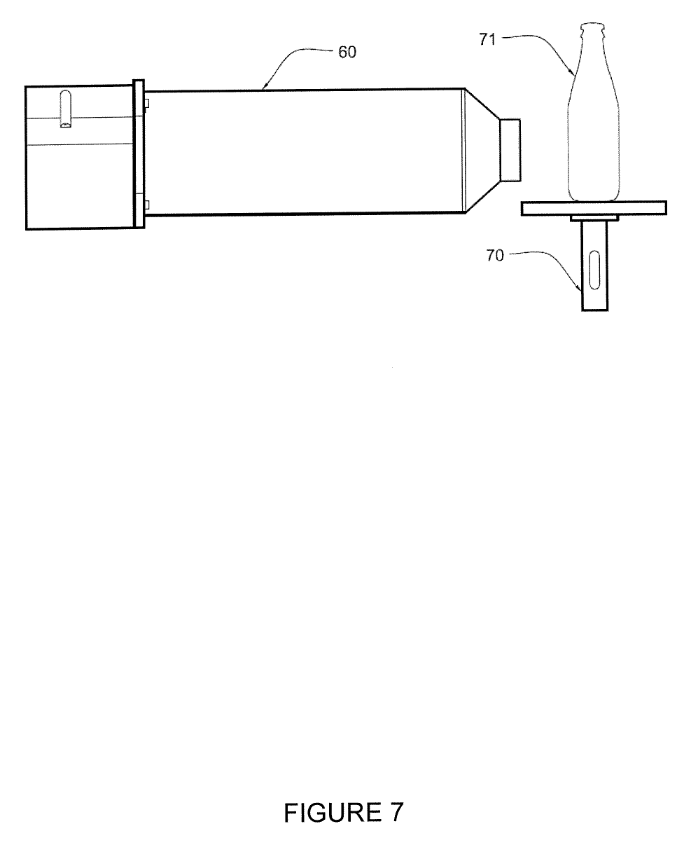

FIG. 7 shows a typical bottle plate assembly 70 with the container label surface heating apparatus 60 installed. In one exemplary embodiment of the invention, an air heater assembly such as a SureHeat® MAX as sold by Osram Sylvania of Exeter, N.H. supplies heated compressed air to the label surface of the container 71 in the range of 250° to 350° F. depending on the labeler speed. The container label surface heating apparatus 60 raises the temperature of the label surface on the container 71 to a minimum temperature of 85° F. which improves the wet out and the clarity of synthetic cold glue adhesives such as N•Cryl™ CB-1000B as sold by Cork Industries of Folcroft, Pa.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

We claim:

1. A glue pallet for applying labels, comprising:
a pallet base; and
an adhesive transfer surface affixed to the pallet base.

2. The glue pallet of claim 1, further comprising an adhesive to permanently bond the adhesive transfer surface to the base.

3. The glue pallet of claim 1, wherein the adhesive transfer surface is an elastomer foam.

4. The glue pallet of claim 3, wherein the elastomer foam is a closed-cell polyurethane foam.

5. The glue pallet of claim 3, wherein the elastomer foam is a closed-cell polypropylene foam.

6. The glue pallet of claim 3, wherein the elastomer foam is a non-absorbent, non-swelling, chemical resistant, abrasion resistant, polar, closed-cell polyurethane foam.

7. The glue pallet of claim 3, wherein the elastomer foam is a non-absorbent, non-swelling, chemical resistant, abrasion resistant, non-polar, closed-cell polypropylene foam.

8. The glue pallet of claim 1, wherein the pallet base is aluminum.

9. An apparatus for applying labels, comprising:
an anvil; and
a gripper finger, said gripper finger adapted to push the label toward the anvil.

10. The apparatus of claim 9, wherein the gripper finger has a rounded, concave contact surface.

11. The apparatus of claim 9, wherein the anvil has a convex mating surface.

12. A heater apparatus for label adhesive activation, comprising:
one or more heating rings adapted to convey heated air proximate to the adhesive side of a label.

13. The heater apparatus of claim 12, further comprising:
a source of heated air; and
an air distribution line connected to the source of heated air and the one or more heating rings.

14. The heater apparatus of claim 12, further comprising a plurality of small holes in one or more of the heating rings, said holes adapted to emit heated air onto the adhesive side of a label.
